(19) United States
(12) Patent Application Publication
(10) Pub. No.: US 2008/0154634 A1
(43) Pub. Date: Jun. 26, 2008

(54) Lien/levy inquiry system

(75) Inventors: Michael Willette, Millbury, MA (US); Michael Guertin, Bradford, MA (US)

Correspondence Address: Hiscock & Barclay, LLP, One Park Place, 300 South State Street, Syracuse, NY, 13202-2078, US

(73) Assignee: University of Massachusetts Medical School, Shrewsbury, MA (US)

(21) Appl. No.: 11/642,197

(22) Filed: Dec. 20, 2006

(51) Int. Cl. G06Q 50/00

(52) U.S. Cl. 705/2

(57) ABSTRACT

Systems and methods for obtaining complete economic recovery for the costs of medical treatment of a person covered by Medicare or Medicaid. In the invention as described herein, a person who requires and receives medical treatment under Medicare or Medicaid, or the health care provider who provides such services, obtains recovery of costs by the use of a system of identifying a third party who carries a legal obligation to reimburse some or all of the expenses of the treatment. The systems and methods described use internet-mediated communication systems to identify such third parties, and use such systems to arrange for, and possibly to receive, reimbursement for expenses.

### FIELD OF THE INVENTION

The invention relates to business methods for financial accounting in general and particularly to a system and method that employs web-based inquiries to determine who the relevant financial parties to a specific matter might be.

### BACKGROUND OF THE INVENTION

At present in the field of medical insurance, there is often no convenient way to determine all of the parties who may have responsibility for costs such as the medical costs associated with treating a patient who has been in an incident or accident for which a third party may be liable to pay. In particular for hospitals, health care providers, doctors or other entities, the costs of treatment are first expended and thereafter the relevant parties responsible for paying the costs of treatment are identified. In some instances, a patient or injured party may agree to a settlement without informing the medical facility that provided services, in which case the medical facility may incur a loss that should properly be compensated, but is not compensated.

There is a need for systems and methods that identify all appropriate parties having an interest in such matters so that a proper financial accounting and outcome can be obtained.

### SUMMARY OF THE INVENTION

In one aspect, in a system for providing medical treatment for a person who is legally eligible for Medicare, Medicaid or managed healthcare benefits wherein one or more third parties are liable for settlement costs with the person, the invention relates to an improvement comprising an electronic communication apparatus and system useful for communication among at least three of the person, a legal representative of the person, a health care provider that treated the person, a third party that is liable for settlement costs, and a Medicare Secondary Payer Recovery Contractor.

In another aspect, in a method of providing medical treatment for a person who is legally eligible for Medicare, Medicaid or managed healthcare benefits wherein one or more third parties are liable for settlement costs with the person, the invention features an improvement comprising conducting communications using electronic communication methods among at least three of the person, a legal representative of the person, a health care provide that treated the person, a third party that is liable for settlement costs, and a Medicare Secondary Payer Recovery Contractor, said communication occurring between at least two of the three communicators at any one time.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a flow chart that shows the various steps in an exemplary process involving a Claimant, according to principles of the invention.

### DETAILED DESCRIPTION OF THE INVENTION

As used herein, the following acronyms will have the following meanings: the term Medicare Secondary Payer will be represented by the acronym “MSP.” The term MSP Recovery Contractor will be represented by the acronym “MSPRC.” The MSPRC is a contractor of the United States Department of Health & Human Services. The term Third Party Liability will be represented by the acronym TPL. The term Massachusetts Department of Industrial Accidents will be represented by the acronym DIA. As used herein, M.G.L. refers to Massachusetts General Laws.

As used herein, certain terms are defined as follows. A Claimant is a person who is legally eligible for Medicare or Medicaid benefits. The terms “Claimant's heir” and “Claimant's estate” are used as examples of successors or assigns of a Claimant.

### History and Background of Claims Recovery

In March of 1998, Massachusetts Governor Paul Celluci signed legislation refining the Insurance Claim Payment Intercept Program (“ICPIP”) program. This initiative is governed by M.G.L 175§24D which requires insurance companies to exchange information with DOR on any non-recurring insurance payments over $500. On Jul. 1, 2003 Massachusetts Governor Mitt Romney signed into law MGL 175§24E, which expanded the ICPIP to include the Division of Medical Assistance (“DMA”) and the Department of Transitional Assistance (“DTA”).

There are two methods in which this information can be exchanged. One is by way of an instant match method in which an insurer can check via website to determine if a lien has been placed on the claimant's account. This is accessible 24 hours per day. Another method is via fax. The Massachusetts Department of Revenue (“DOR”)/Masshealth has up to 10 days to respond to the inquiry. Insurers most commonly use the instant match method because it is more convenient and cost effective.

The program is expected to obtain access to information to recover for any loss it has incurred as a result of the incident or accident. Since the claimant has already assigned his or her rights to Masshealth, it should be able to act on his or her behalf to identify potential third parties. To maximize the program effectiveness, the system allows an insurer to log onto the website and provide an identifier (such as a Social Security number) that allows accessing both the DOR and DMA databases together.

### ATRU Operational Overview

In the approach used heretofore, the ATRU unit is designed to investigate referrals and generate cases to track for future recovery using a manual method. This is a costly and inefficient use of resources. By way of example, the ATRU unit currently has approximately 70,000 active and open cases, of which only about 3,000 are actually being negotiated. It is estimated that over 25,000 cases currently open that have no chance of recovery because no monies were owed. When the Masshealth member never settles or received monies when no monies were owed, the case remains active under the previous approach. Significant cost and manpower savings can be achieved by reducing the steps involved and only handling a case once at the time of settlement.

Last year the TPL unit created liens in over 25,000 cases and recovered approximately 13.2 million dollars. In order for TPL to accomplish its mission one must identify leads on third party claims brought by Medicaid members. In the approaches taken heretofore, reliance is placed on a variety of sources for referrals, including hospitals, attorneys, MassHealth Enrollment Centers, data matches, Department of Transitional Assistance offices, and insurance companies. Although these sources have been invaluable in assisting recovery efforts in the past, there are many cases that settle every year without Masshealth's knowledge. It is reasonable to explore other potential referral sources to avoid these missed opportunities and to maximize collections.

The Department of Revenue currently uses the Insurance Claim Intercept Program (ICIP). This initiative requires insurance companies to exchange information with DOR to identify past due child support debts.

The ICIP derives from M.G.L 175§ 24D which states that “Prior to making any nonrecurring payment equal to or in excess of $500 to a claimant under a contract of insurance, every company authorized to issue policies of insurance pursuant chapter 175 shall exchange information with the IV-D agency”. Before any insurer an issue a non-recurring settlement payment over $500 they must exchanging information whit both DOR and MassHealth. They accomplish this through a variety of resources to allow the insurer inquire on possible liens, by using either the Internet or filling out necessary paper forms.

In the present invention, both DMA and DTA will be queried. The potential cost savings for both of these organizations is forecast to be in the millions.

### ATRU Analysis

By way of example, in the field of automobile insurance, ATRU collected approximately 3.2 million dollars in a recent year. This amount related to a total of 1,421 cases with an average settlement of $2,313.41. Bodily Injury Claims (BI) are one of the primary sources of recovery. However, in the same year the industry figures indicate that a total of 56,479 BI claims were settled at an average claim settlement of $10,399.00 with an industry pay out of $587,325,121. Therefore the ATRU recovery represented only a small fraction of the total settlement in those cases.

The population statistics indicate that the Massachusetts Medicaid population is approximately 900,000 as compared to the general population of 6.1 million, or stated in alternative terms, the Masshealth recipients comprise 15% of the total population. It would be expected that out of the 56,479 BI claims that settled, ATRU should have collected on approximately 8,471 cases (15%), rather than the actual 1,421, or about 7000 additional cases, this is a rough estimate. One can try to estimate how so many cases could have settled without the ATRU becoming aware of the settlement.

The ATRU system relies on the legal requirement that a “Masshealth member is to notify the DMA or DTA within 10 days in writing upon commencement of a civil action or other proceeding to establish the liability of any third party.” This derives from both M.G.L. 118E§22 & 18§5G. However, it is apparent that a flaw in the system is reliance upon the member to notify the respective agencies. It is clear that there is often a failure to make any communication at all by the Masshealth member. In many instances, the first indication that an incident or accident has occurred is the receipt of notification from another source that recipient has been involved in an incident or an accident. In response, a communication from to the Masshealth member termed a “no lead” is generated to determine what may have taken place. In a recent year, approximately 15, 890 “no leads” were sent to clients. It was estimated that over 13,000 of those were for auto accident inquiries. The ATRU received only 138 responses. It follows that the 13,000 “no leads” not responded to reflect the unidentified 7,000 BI claims. The possible recoveries in these roughly 7000 cases were lost because there is no mechanism in place to cause the insurer or attorney to inquire with the ATRU unit about any potential lien.

Three are five primary sources of recovery related to automobile accidents, industrial accidents, general liability, product liability, and malpractice. These five sources accounted for $13.2 million respectively in a recent year.

The four data matches performed with the DIA produced over 23,000 hits. The DIA provided the following statistics. In three recent years, a total of 123,000 claims were filled: approximately 50% were employee claims, approximately 25% were discontinuance, and approximately 25% were third party claims.

Upon receiving a hit in the course of matching, a lien is generated and sent to the DIA to be enforced at the time a settlement is obtained as a lump sum. Unfortunately, of the 23,000 hits, only 5,000 were valid claims. This is an inefficient form of information inquiry. An inordinate amount of resources are exhausted in an attempt to complete one of these matches. In addition, there can be issues when asking another agency (here, the DIA) to cooperate with the match.

In addition, recent experience has shown that even with a lien perfected with the DIA, there is no guarantee that the lien will be enforced. In the past, there have been cases that have settled with a lien in place without any contact with the ATRU. Insufficient data along with available resources inhibits the ability to generate a figure to determine the number of cases settled without the knowledge of the ATRU. What we can determine is that most claims filled are only temporary employee claims. This means that most claims filled by employees are for wages lost for only a short period (for example, only 14-30 days). Then the employee goes back to work. Many cases involve such claims. A result is a large population of cases that remain open in the system that were identified in the match.

Malpractice results in the largest collection per incident. In a recent year ATRU collected $1.9 million on 34 cases. A data match was performed with Promutual that produced 275 hits and resulted in collections of $595,148. The industry in a recent year paid a total of $ $225 million with an average of approximately $384,300 on 309 claims.

Promutual and CRICO/RMF, 101 Main Street, Cambridge, Mass. 02142 (“Risk Management”) insure approximately 95% of the total licensed medical community in the Commonwealth of Massachusetts. In the past, there has been no mechanism in place requiring either organization to inquire with ATRU upon issuing a settlement check.

The invention in one embodiment provides a Web-based referral/identification system and associated methods. Under the systems and methods of the system, there is an exchange of information via a network such as the internet for the identification of parties that may have a legal interest in monies derived from a cause of action or civil suit, for example one due to the potential negligence of another party.

The invention (in both a system and a process) maps various aspects of information that various parties of interest need to verify and assert their financial interests on a claim of monies owed from a cause of action or civil suit, and the settlement proceeds that flow therefrom. The system and method accomplish this end by interfacing and/or interacting with insurance companies, legal representative of the parties, various databases, with a central clearing agency, and with others as needed, taking into account the developing laws and regulations that apply to various elements of the matter. The invention uses like processes to exchange information with all relevant parties that have an interest in a tort or workers compensation case. This is an improvement over the procedures (and prior art) currently used throughout the nation.

In some embodiments, the systems and methods of the invention are useful to recover money that otherwise might be overlooked and can be applied nationally for Medicaid, Medicare, and managed care organizations. In some embodiments, Medicaid and Medicare agencies are expected to be able to use this system to facilitate the identification of legally liable third parties as required under Federal law. Managed care organizations are expected to be able to use this process to insert a lien under their coordination of benefits contract clause. One issue that may need to be resolved in some embodiments of the invention as applied in systems that involve participation of government entities may be the passage of appropriate legislation or rulemaking to allow the systems and methods to be approved.

The systems and methods of the invention provide for the identification of parties to a covered matter and for the exchange of information via website to permit financial recovery by one or more of Medicare, Medicaid or health care organizations that have incurred a loss as a result or alleged incident or accident for which a third party may be liable. The exchanging of information may occur between and among legal counsel, insurance companies, and or legal agents of the respective named parties. Examples of parties that may beneficially use the systems and methods of the invention for such financial recoveries include Medicare Second Payers as defined by Section 1862(b) of the Social Security Act; Medicaid agencies as defined by 42 U.S.C. §1396(a)(25)(a) (under which a state must take all reasonable efforts to identify liable third parties); and Health Maintenance Organizations, in instances where third party recovery is covered in a contract, for example as expressed in a coordination of benefits clause.

In an exemplary system and method, the information that can be exchanged includes information about a person suffering an accident or injury (e.g., a claimant), information about a legal representative of a party (e.g., an attorney), information about parties having possible financial responsibility for the costs of the claimant (such as an insurance company, or a parent), and information about third parties who may have financial liability for causing the claimant to bring the claim (such as a party involved in an accident).

Illustrative examples of information about a claimant can include, but are not limited to, the claimant's full or legal name and the claimant's address, his or her Social Security number, his or her date of birth, the date of the claimant's loss, a description of the injuries suffered, for example by the type of injury, and any insurance coverage that the claimant may have.

Illustrative examples of information about a legal representative or attorney can include, but are not limited to, the attorney's full name, the name of the attorney's firm or practice, an address, a phone number, fax number, e-mail address, tax ID number, the attorney's registration or board number, a settlement amount, and other information relevant about the matter.

Illustrative examples of information about a party having possible financial responsibility for the costs of the claimant (such as an insurance company) can include, but are not limited to, the legal name of the insurance company, its address, its tax ID number, the name of an adjuster, the adjuster's phone number and email address, a claim number, a settlement amount, and identifying information about the incident such as the name of the insured, the date of the loss, information identifying the type and extent of injuries, and any other relevant information about the matter.

A settlement amount is used in the system and methods of the invention by any or all of the insurance companies, attorneys, and legal agents such as contractors and/or vendors for either the Medicare or Medicaid programs.

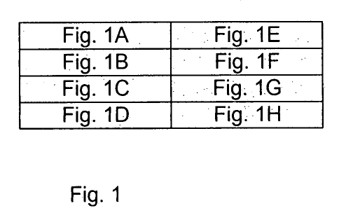

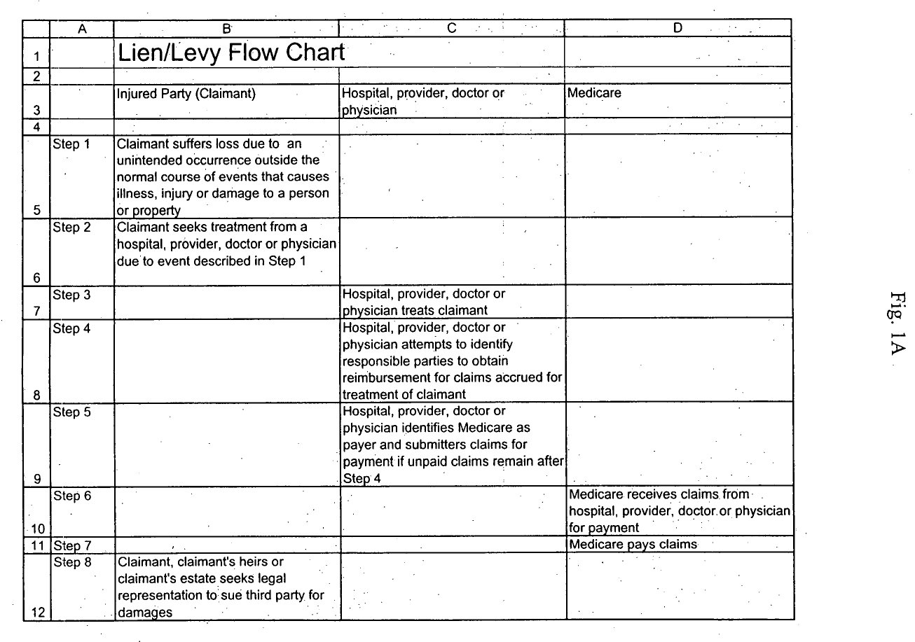

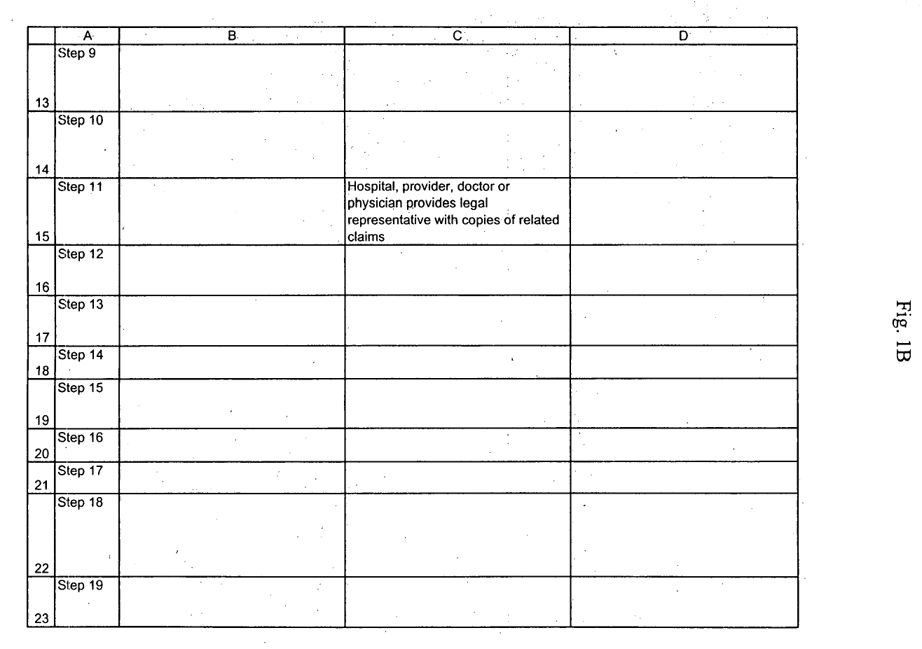

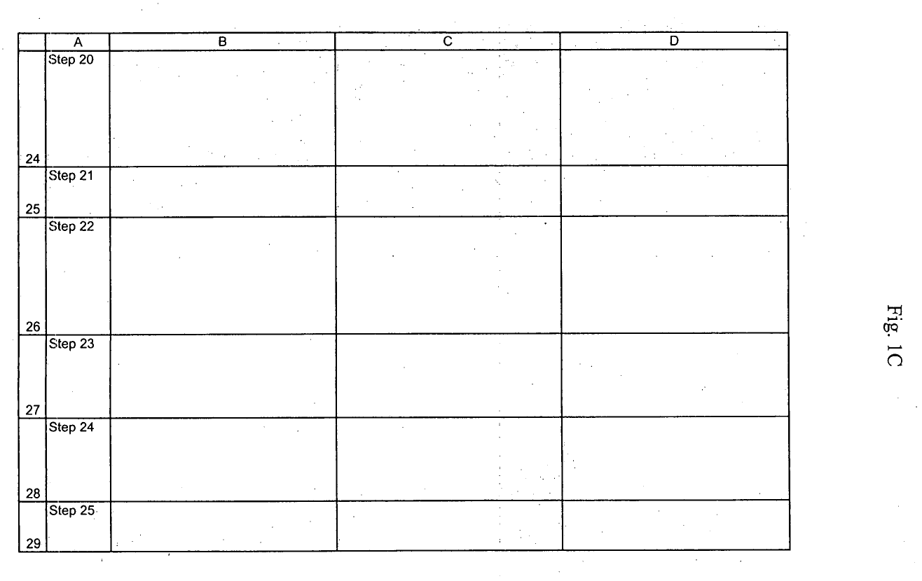

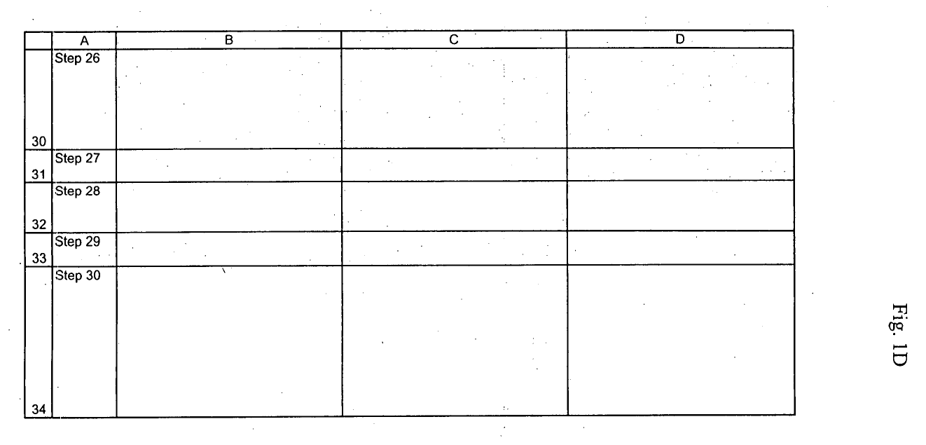

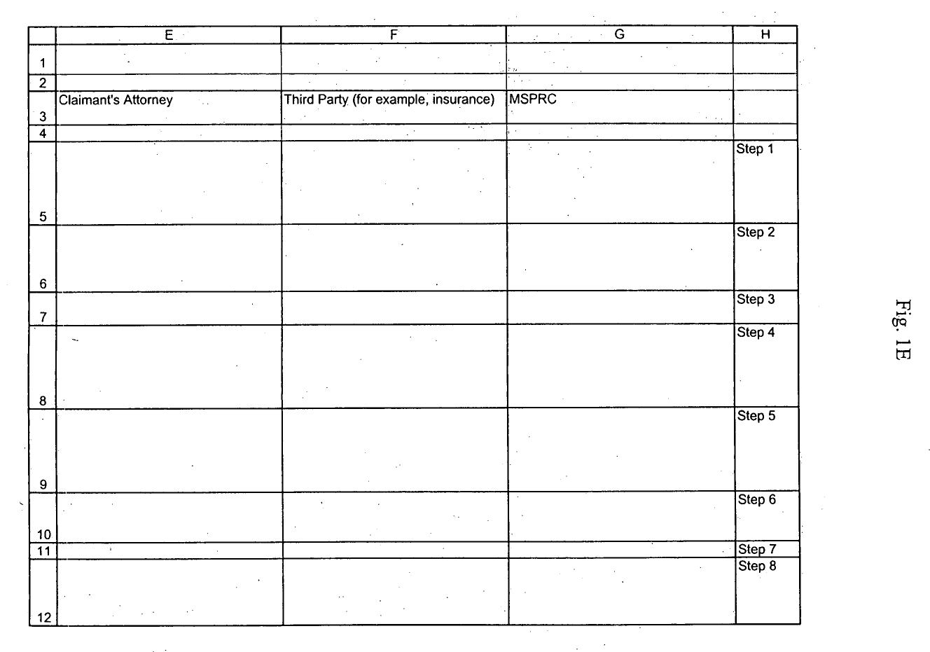

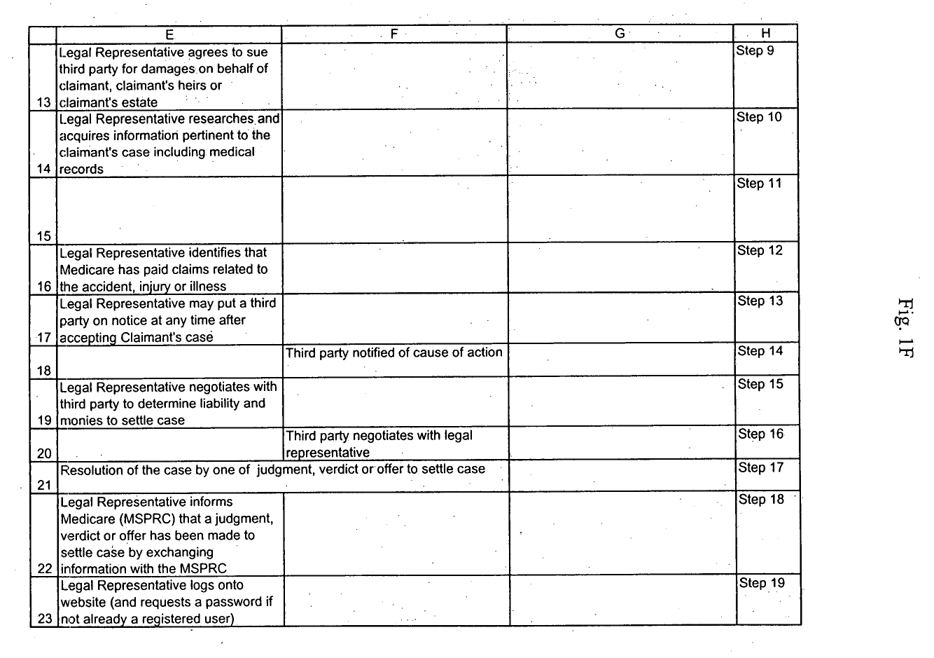

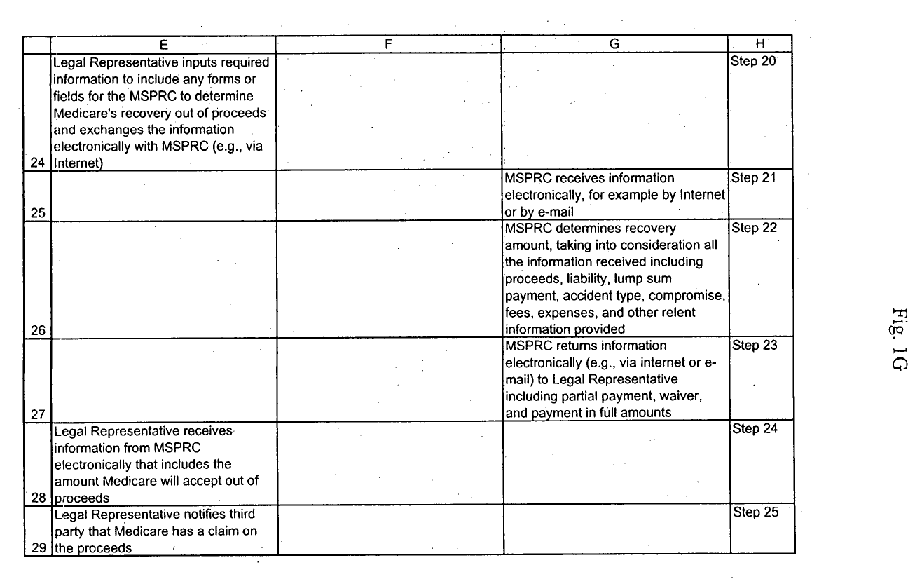

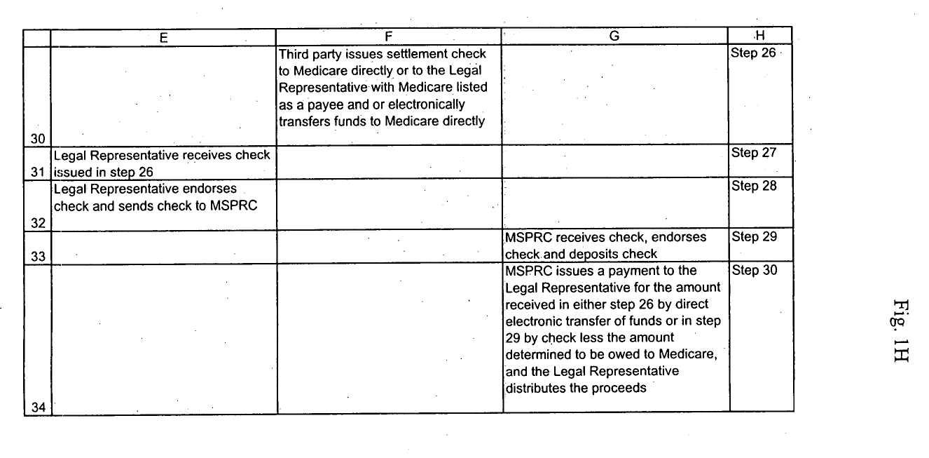

We now describe an example of a Medicare attorney lien interface. FIG. 1 is a flow chart that shows the various steps in a process involving a Claimant.

As indicated in FIG. 1, step 1, Claimant is involved in an event that leads to medical treatment, such as an auto accident in which he sustains neck and back injuries. The invention contemplates other kind of events, such as an accident or injury on the job, an illness (perhaps caused by the acts or omissions of a third party), or other circumstances that can lead to a need for medical treatment. He receives treatment at a hospital or from another health care provider (such as a private medical practice, a physician, a health maintenance organization or HMO), as indicated at step 2. The hospital or other health care provider treats the Claimant, as indicated at step 3, for which the total claims amount to $3,616.72.

The hospital or other health care provider attempts to identify responsible parties to obtain reimbursement, as indicated at step 4.

If there remain unpaid claims, the hospital or other health care provider submits claims for payment to Medicare, as indicated at step 5.

Medicare receives the claims, as indicated at step 6.

Medicare pays the bills and incurs a loss, as indicated at step 7.

As indicated at step 8, the Claimant (or his successors) hires an attorney (Legal Representative) to sue a third party for damages.

As indicated at step 9, the Legal Representative agrees to sue a third party for damages on behalf of the Claimant, the Claimant's heirs or the Claimant's estate.

As indicated at step 10, the Legal Representative researches and acquires information pertinent to the Claimant's case including medical records. The Legal Representative is expected to perform research to identify any possible third party that might have a legal liability for paying the costs associated with the treatment of the Claimant, or that might be responsible for payments to the Claimant as a consequence of the medical treatment or the situation in which the need for medical treatment arises. For example, the Legal Representative might look to owners or operators of vehicles, equipment or premises related to the event that created the need for medical treatment, insurers of such owners or operators, and other potentially liable third parties. The research performed by the Legal representative can include the use of various electronic communication apparatus, systems and methods including internet-mediated communication systems and methods. Communications by the Legal representative typically include use of electronic communication methods such as the internet and/or email, and are conducted among the person (e.g., the Claimant), a legal representative of the person, a health care provide that treated the person, a third party that is liable for settlement costs, and a Medicare Secondary Payer Recovery Contractor. Often, the communications occur between two of the communicators, but in some instances, communications can occur among three or more of the communicators, for example using email with multiple recipients, or using teleconferencing, or equivalent communication using Internet-mediated communications.

As indicated at step 11, the hospital or other health care provider provides legal representative with copies of related claims.

As indicated at step 12, the Legal Representative identifies that Medicare has paid claims related to the accident, injury or illness.

As indicated at step 13, the Legal Representative may put a third party on notice at any time after accepting claimant case.

As indicated at step 14, the third party is notified of cause of action.

As indicated at step 15, the Legal Representative negotiates with the third party to determine liability and monies to settle the case.

As indicated at step 16, the third party negotiates with the Legal Representative.

As indicated at step 17, a resolution of the case by one of judgment, verdict, or offer to settle the case is reached.

As indicated at step 18, the Legal Representative informs Medicare (by way of the MSPRC) that a judgment, verdict or offer has been made to settle case by exchanging information with the MSPRC.

As indicated at step 19, the Legal Representative logs onto website (and requests a password if not already a registered user).

As indicated at step 20, the Legal Representative inputs required information to include any forms or fields for the MSPRC to determine Medicare's recovery out of proceeds and exchanges the information electronically with MSPRC (e.g., via Internet).

As indicated at step 21, the MSPRC receives information electronically, for example by Internet or by e-mail.

As indicated at step 22, the MSPRC determines recovery amount, taking into consideration all the information received including proceeds, liability, lump sum payment, accident type, compromise, fees, expenses, and other relent information provided.

As indicated at step 23, the MSPRC returns information electronically (e.g., via internet or e-mail) to Legal Representative including partial payment, waiver, and payment in full amounts.

As indicated at step 24, the Legal Representative receives information from MSPRC electronically that includes the amount Medicare will accept out of proceeds.

As indicated at step 25, the Legal Representative notifies the third party that Medicare has a claim on the proceeds.

As indicated at step 26, the third party issues a settlement check to Medicare directly or to the Legal Representative with Medicare listed as a payee and or electronically transfers funds to Medicare directly.

If a check is issued according to step 26, the Legal Representative receives the check as indicated at step 27.

If a check is issued according to step 26, the Legal Representative endorses the check and sends the check to MSPRC, as indicated at step 28.

If a check is issued according to step 26, the MSPRC receives the check, endorses the check and deposits the check as indicated at step 29.

As indicated at step 30, the MSPRC issues a payment to the Legal Representative for the amount received in either step 26 by direct electronic transfer of funds or in step 29 by check less the amount determined to be owed to Medicare, and the Legal Representative distributes the proceeds.

In the hypothetical used as an illustrative example the following events occur. The claimant's attorney researches medical claims and records and identifies that Medicare has paid bills either by direct or constructive notice.

After several months, the attorney and third party come to an agreement to settle the case for the bodily injury policy limit of $40,000.

The attorney logs into Medicare website and electronically exchanges information with the MSPRC. The information exchanged includes claimant information, third party information, liability settlement reimbursement summary, and any other information required.

The MSPRC receives the information and determines the following:

| | |
|---|---|
| Claimant | John Q. Public |
| SSN# | 123-45-6789 |
| Date of Birth | Sep. 25, 1971 |
| Date of loss | Jan. 1, 2000 |
| Third party | XYZ insurance |
| | 789 Anywhere Drive |
| | Boston, MA 11111 |
| Adjuster | Bob Smith |
| Adjuster phone | 617-123-0000 |
| Claim# | AAI582 |
| Types of injuries | Neck/Back |
| Accident type | Auto |

Brief Description of accident—My client was sitting in his car which was stopped at the corner of Commonwealth Avenue and Berkeley Street at a red light. The car was struck from behind.

| | |
|---|---|
| Attorney name | John J. Attorney |
| Address | 56 Legal Street |
| | Boston, MA 22222 |
| Phone | 617-123-3333 |
| e-mail | John@lawoffice.com |

Table I shows the calculations that are performed to determine a settlement.

TABLE I
Medicare Liability Settlement Claim Reimbursement Summary

| Claimant: John Q. Public | |
|---|---|
| 1. Amount of Settlement | $40,000.00 |
| 2. Medicare Payments | |
| 3. Total Medicare Payments | $3,616.72 |
| 4. Attorney fees* | $11,666.67 |
| (33⅓% of line 1, if applicable) | |
| 5. Other procurement costs incurred | $367.91 |
| 6. Total procurement costs | $12,034.58 |
| 7. Ratio of procurement costs to | 30.09% |
| settlement (line 6/line 1) | |
| 8. Medicare's share of procurement | $1,088.14 |
| costs (line 3 * line 7) | |
| 9. Total provider charges | |
| 10. Medicare's claim to be recovered | $2,528.58 |
| (line 3 minus Line 8) | |

| | | % of Total |
|---|---|---|
| | | Settlement |
| Distribution: | | |
| Settlement Amount: | $40,000.00 | |
| Minus Attorney Fees & Costs: | $12,034.58 | 30.09% |
| Minus Medicare Claim: | $2,528.58 | 6.32% |
| Amount Claimant Retains: | $25,436.84 | 63.59% |
| Attorney's Proposed Compromise: | | |
| Settlement Amount: | $40,000.00 | |
| Minus Attorney Fees & Costs: | $12,034.58 | 30.09% |
| Minus Medicare Claim: | $1.00 | |
| Amount Claimant Retains: | $27,964.42 | 69.91% |
| Medicare's Proposed Compromise: | | |
| Settlement Amount: | $40,000.00 | |
| Minus Attorney Fees & Costs: | $12,034.58 | 30.09% |
| Minus Medicare Claim: | $2,528.58 | 6.32% |
| Amount Claimant Retains: | $25,436.84 | 63.59% |

The MSPRC returns information back to the attorney via lien interface, e-mail, or correspondence.

The attorney receives information and notifies the third party. The third party either issues payment directly to Medicare, to the attorney with Medicare listed as a payee, or electronically transfers funds to Medicare. If the settlement check is issued to the attorney with Medicare listed as a payee, the attorney endorsees the check and sends it to the MSPRC. The MSPRC receives the settlement check, deposits the check, and sends a check back to the attorney for the settlement amount less the Medicare claim amount. The Attorney receives check form Medicare and disburses the funds accordingly.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. In a system for providing medical treatment for a person who is legally eligible for Medicare, Medicaid or managed healthcare benefits wherein one or more third parties are liable for settlement costs with the person,
the improvement comprising:
an electronic communication apparatus and system useful for communication among at least three of the person, a legal representative of the person, a health care provide that treated the person, a third party that is liable for settlement costs, and a Medicare Secondary Payer Recovery Contractor.

2. In a method of providing medical treatment for a person who is legally eligible for Medicare, Medicaid or managed healthcare benefits wherein one or more third parties are liable for settlement costs with the person,
the improvement comprising:
conducting communications using electronic communication methods among at least three of the person, a legal representative of the person, a health care provider that treated the person, a third party that is liable for settlement costs, and a Medicare Secondary Payer Recovery Contractor, said communication occurring between at least two of the three communicators at any one time.
